(19) United States
(12) Patent Application Publication
(10) Pub. No.: US 2004/0091176 A1
(43) Pub. Date: May 13, 2004

(54) Apparatus and method for handwritten character font generation, and computer-readable storage medium recording program for the same

(76) Inventor: Xuqiang Bai, Ibaraki-ken (JP)

Correspondence Address: NATH & ASSOCIATES, PLLC, Sixth Floor, 1030 15th Street, N.W., Washington, DC, 20005, US

(21) Appl. No.: 10/691,603

(22) Filed: Oct. 24, 2003

(30) Foreign Application Priority Data
Oct. 25, 2002 (JP) P2002-310904

(51) Int. Cl. G06K 9/54; G06K 9/18; B41F 1/00

(52) U.S. Cl. 382/305; 382/186; 358/1.11

(57) ABSTRACT

An apparatus includes: (a) a character image extraction extracting character image data of handwritten characters filled into character entry boxes from image data scanned from a character entry sheet in which the handwritten characters are filled into the character entry boxes corresponding to respective character codes; (b) a character positional information storage section storing character positional information of font character space defined for each of characters; (c) a character positional information calculation section calculating the amount of movement for moving the extracted character image data to a character position of the font character space defined in the character positional information; (d) a character position alignment section moving the character image data to the character position of the font character space defined in the character positional information, based on the calculated amount of movement; and (e) a character font generation section generating font characters of the handwritten character font based on the moved character image data.

### BACKGROUND OF THE INVENTION

1. Field of the Invention

The present invention pertains to technology for generating a digital font (herein below, abbreviated to “font”) used for an information-processing apparatus, a printer, or the like. In particular, the present invention pertains to an apparatus, a method, and a computer-readable storage medium recording a program for generating fonts based on user's handwritten characters.

2. Description of the Related Art

Representative fonts, such as “Mincho” style (typical Japanese typeface), “Gothic” style or the like are used with printers or an information processing apparatus such as a personal computer, a Personal Digital Assistant (PDA) or the like.

Although such the representative fonts are beautifully designed in appearance, conversely, it may give a reader of a printed document an impression of uniformity and a lack of individuality.

In order to solve such a problem, in response to the need to use a user's original font for personal documents, such as a postal card, a sealed letter or the like, a font generation apparatus for generating a handwritten character font based on user's handwritten characters is disclosed in the Japanese Patent Laid Open Publication (Kokai) No. 2002-062862.

However, when a handwritten character font is generated using the font generation apparatus disclosed in the above-mentioned reference, it is necessary to fill in handwritten characters needed for generation of the all handwritten character font in a character entry sheet. In this case, although character entry boxes for aligning a character position are printed on the character entry sheet, it is a great mental burden to the user to have to fill in all characters so that all characters do not protrude from the character entry boxes. Furthermore, the handwritten characters filled into the character entry boxes have a strong tendency to be filled in rather smallish generally in order to fit into the character entry boxes. Therefore, a phenomenon in which the size or the positioning of the characters filled into the character entry boxes is not fixed has occurred.

Therefore, in the case where a handwritten character font is generated based on handwritten characters, since intervals between character pictures are not fixed or variations of the row of the character pictures have occurred, there is a problem that the appearance of the document printed using the handwritten character font is not good. Such a problem has been especially noticeable in regard to voiced sound characters and p-sound characters among “Hiragana” characters (the rounded Japanese phonetic syllabary characters) and “Katakana” characters (the angular Japanese phonetic syllabary characters).

### SUMMARY OF THE INVENTION

An apparatus for handwritten character font generation according to an embodiment of the present invention includes: (a) a character image extraction section configured to extract character image data of handwritten characters filled into character entry boxes from image data scanned from a character entry sheet in which the handwritten characters are filled into the character entry boxes corresponding to respective character codes; (b) a character positional information storage section configured to store character positional information of font character space defined for each of characters; (c) a character positional information calculation section configured to calculate the amount of movement for moving the extracted character image data to a character position of the font character space defined in the character positional information; (d) a character position alignment section configured to move the character image data to the character position of the font character space defined in the character positional information, based on the calculated amount of movement; and (e) a character font generation section configured to generate font characters of the handwritten character font based on the moved character image data.

Further, a computer readable storage medium recording a program for handwritten character font generation according to an embodiment of the present invention, the program executing in a handwritten character font generation apparatus, the program includes: (a) extracting character image data of handwritten characters filled into character entry boxes from image data scanned from a character entry sheet in which the handwritten characters are filled into the character entry boxes corresponding to respective character codes; (b) calculating the amount of movement for moving the extracted character image data to a character position of font character space defined in character positional information; (c) moving the character image data to the character position of the font character space defined in the character positional information based on the calculated amount of movement; and (d) generating font characters of the handwritten character font based on the moved character image data.

Furthermore, A method for handwritten character font generation in an apparatus for handwritten character font generation according to an embodiment of the present invention, the method comprising: (a) extracting character image data of handwritten characters filled into character entry boxes from image data scanned from a character entry sheet in which the handwritten characters are filled into the character entry boxes corresponding to respective character codes; (b) calculating the amount of movement for moving the extracted character image data to a character position of font character space defined in character positional information; (c) moving the character image data to the character position of the font character space defined in the character positional information based on the calculated amount of movement; and (d) generating font characters of the handwritten character font based on the moved character image data.

### BRIEF DESCRIPTION OF THE DRAWINGS

FIG. 1 is a schematic diagram showing an example of components of a handwritten character font generation apparatus according to an embodiment of the present invention.

FIG. 2 is a block diagram showing an example of an internal structure of a personal computer among the handwritten character font generation apparatus shown in FIG. 1.

FIG. 3 is a flow chart showing the example of the processing operation for handwritten character font generation according to an embodiment of the present invention.

FIG. 4 is a schematic diagram showing an example of a layout of a character entry sheet used in the handwritten character font generation processing shown in FIG. 3.

FIG. 5 is an illustration for explaining a method of extraction of a handwritten character image filled into the character entry sheet shown in FIG. 4.

FIG. 6 is a flowchart showing the details of the image processing of Step S4 in the handwritten character font generation processing shown in FIG. 3.

FIG. 7 is an illustration for explaining font character space, a circumscribed quadrilateral, a top blank, a bottom blank, a left blank and a right blank.

FIG. 8 is an illustration showing an example of character positional information of ordinary characters stored in the ordinary character positional database shown in FIG. 2.

FIG. 9 is an illustration for explaining specific characters and position fiducial characters corresponding to respective specific characters.

FIGS. 10A and 10B are illustrations for explaining image processing to the specific character image data. FIG. 10B shows an example of font character space of a specific character. FIG. 10A shows an example of font character space of a position fiducial character corresponding to the specific character.

### DETAILED DESCRIPTION

The present embodiment aims to disclose an apparatus, a method, and a computer-readable storage medium recording a program for generating handwritten character font, based on user's handwritten characters, with which the prepared document can be printed finely.

An apparatus for handwritten character font generation according to the present embodiment includes: (a) a character image extraction section configured to extract character image data of handwritten characters filled into character entry boxes from image data scanned from a character entry sheet in which the handwritten characters are filled into the character entry boxes corresponding to respective character codes; (b) a character positional information storage section configured to store character positional information of font character space defined for each of characters; (c) a character positional information calculation section configured to calculate the amount of movement for moving the extracted character image data to a character position of the font character space defined in the character positional information; (d) a character position alignment section configured to move the character image data to the character position of the font character space defined in the character positional information, based on the calculated amount of movement; and (e) a character font generation section configured to generate font characters of the handwritten character font based on the moved character image data.

Further, a computer readable storage medium recording a program for handwritten character font generation according to the present embodiment, the program executing in a handwritten character font generation apparatus, the program includes: (a) extracting character image data of handwritten characters filled into character entry boxes from image data scanned from a character entry sheet in which the handwritten characters are filled into the character entry boxes corresponding to respective character codes; (b) calculating the amount of movement for moving the extracted character image data to a character position of font character space defined in character positional information; (c) moving the character image data to the character position of the font character space defined in the character positional information based on the calculated amount of movement; and (d) generating font characters of the handwritten character font based on the moved character image data.

According to the above composition, since the character image data of the handwritten character is moved to the character position based on the character positional information of the font character space defined for every font character and then font characters are created, the handwritten character font based on the user's own handwritten characters can be created easily, and documents drawn up by using the handwritten character font can be printed with an attractive appearance.

Further, the above-mentioned handwritten character font generation apparatus may further include: (f) a character circumscribed quadrilateral calculation section configured to calculate a circumscribed quadrilateral of a character portion of the character image data from the extracted character image data. And then, the character positional information calculation section calculates the amount of movement for moving the calculated circumscribed quadrilateral to the character position of the font character space defined in the character positional information, and the character position alignment section moves the character image data to the character position of the font character space defined in the character positional information by moving the character portion of the character image data based on the calculated amount of movement.

The above-mentioned program for handwritten character font generation may further include (f) calculating a circumscribed quadrilateral of a character portion of the character image data from the extracted character image data. And then, the amount of movement for moving the calculated circumscribed quadrilateral to the character position of the font character space defined in the character positional information is calculated, and the character image data to the character position of the font character space defined in the character positional information by moving the character portion of the character image data is moved based on the calculated amount of movement.

Furthermore, the character positional information may include information about a ratio of a top blank to a bottom blank and a ratio of a left blank to a right blank, of the circumscribed quadrilateral in the font character space.

Moreover, the character positional information may include information which defines position fiducial characters corresponding to each specific character and information which defines a positional relation between each of the specific characters and each of the position fiducial characters respectively. According to the composition, the handwritten character font of the specific characters, such as voiced sound characters among Hiragana characters and Katakana characters, p-sound characters among Hiragana characters and Katakana characters, and Roman numerals, can be created easily with an attractive appearance.

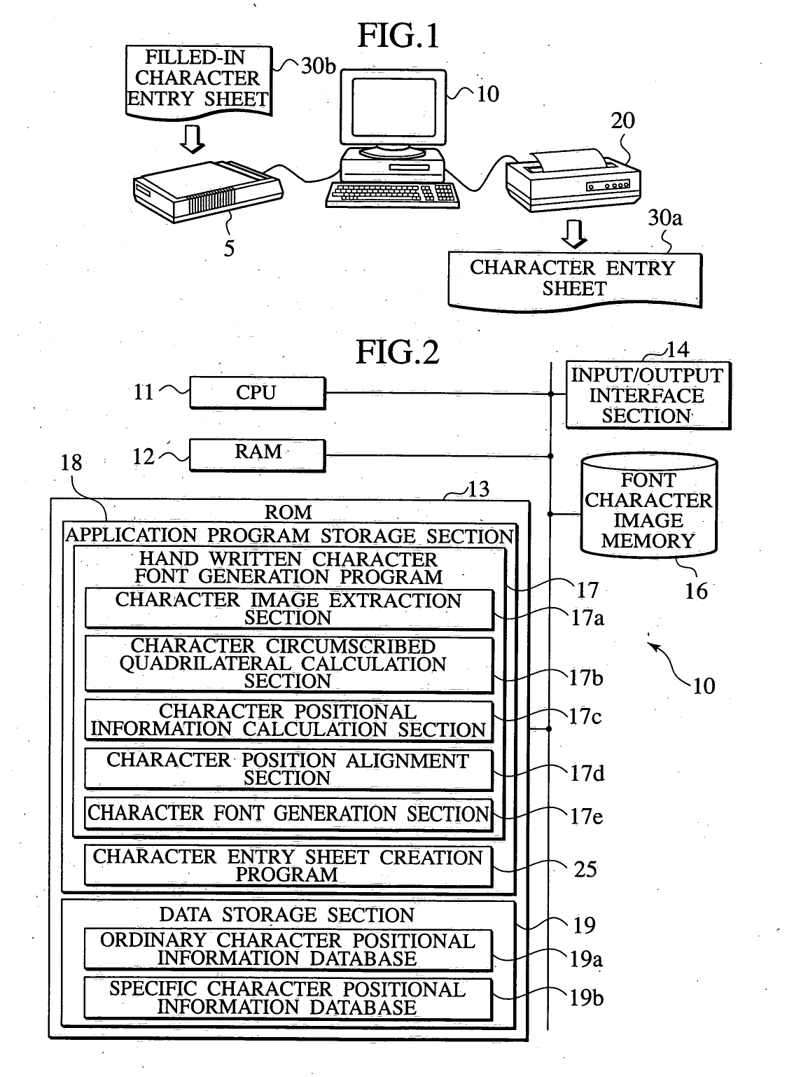

Various embodiments of the present invention will be described herein below with reference to the accompanying FIGS. 1 through 10B. It is to be noted that the same or similar reference numerals are applied to the same or similar parts and elements throughout the drawings, and the description of the same or similar parts and elements will be omitted or simplified.

In this specification, “character” means a symbol symbolized by the combination of dots, stroke, or the like for every division in language in order to express the language visually, and “font” means a character set created using a single typeface. Further, “font character” means each character marking each division of the “font”, and corresponds to each “character” constituting the “font”. Furthermore, “handwritten character font” means a character set, handwritten by a user, which can be regarded as a single typeface. The file format of the “handwritten character font” may be bit map form, or may be vector form which consists of sets of formulas, such as a Bezier curve, a spline curve or the like. Moreover, “character code” means a peculiar set of codes into which the set (character set) of characters, signs or the like are encoded, in order to process the characters and the signs in an information processing apparatus. There are Shifted Japanese Industrial Standard (JIS) Codes, Japanese Extended Unix Code (EUC) or the like as the character codes for processing a Japanese character set, and one character is usually expressed with a 2 bytes code. In addition, there are also character codes for processing Korean language, Chinese language or the like.

[Components of Handwritten Character Font Generation Apparatus]

As shown in FIG. 1, a handwritten character font generation apparatus includes an image scanner 5 for scanning an image from a filled-in character entry sheet 30b in which handwritten characters is filled, a printer 20 for printing a character entry sheet 30a for filling in the handwritten characters, and a personal computer 10 for generating a handwritten character font based on the handwritten characters filled into the filled-in character entry sheet 30b.

In addition, the composition of the handwritten character font generation apparatus is not limited to the above-mentioned composition. For example, the handwritten character font generation apparatus may be configured such as being molded in one piece with each of the above-mentioned composition elements.

[Components of Personal Computer]

As shown in FIG. 2, the personal computer 10 includes a Central Processing Unit (CPU) 11, a Random Access Memory (RAM) 12, a Read Only Memory (ROM) 13, an input/output interface section 14 and a font character image memory 16, and each of the composition elements are connected electrically each other.

The CPU 11 controls operation of the personal computer 10 according to programs stored in the ROM 13. The RAM 12 provides a work area for storing temporarily the various programs and data relating to various operations which the CPU 11 performs.

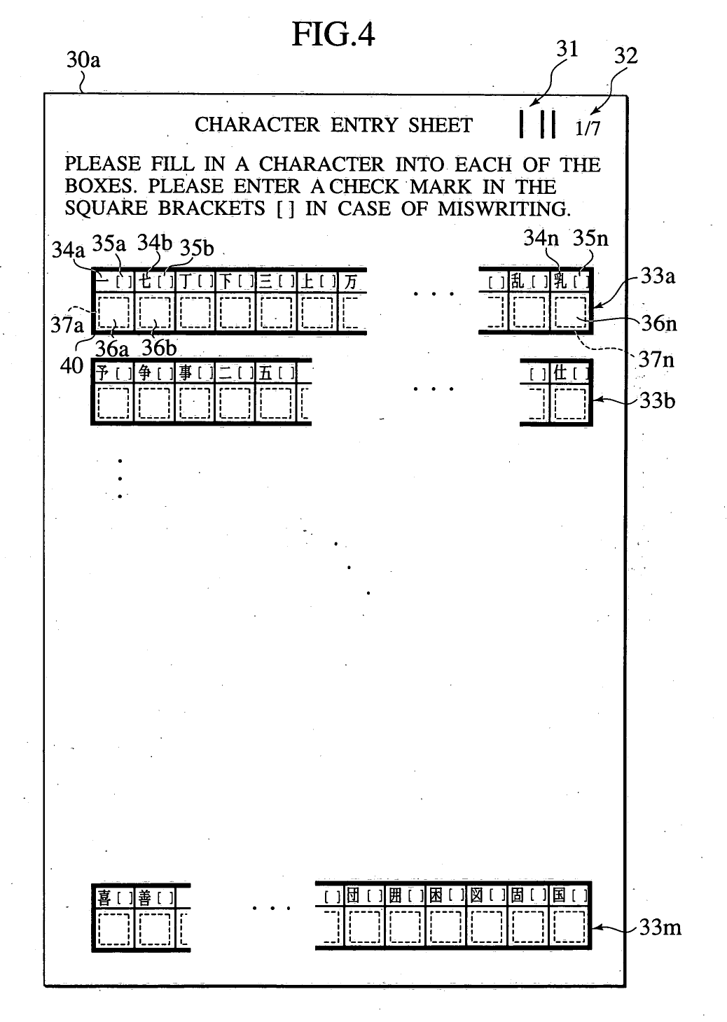

The ROM 13 includes an application program storage section 18 and a data storage section 19. The application program storage section 18 stores a character entry sheet creation program 25 and a handwritten character font generation program 17 which the CPU 11 executes at the time of a handwritten character font creation processing. The data storage section 19 stores a correspondence table (not shown) indicating a correspondence relation between character entry box numbers of the character entry sheet 30a and character codes, and various data required for execution of the application programs, such as an ordinary character positional information database 19a, a specific character positional information database 19b or the like (described later in detail). In addition, although the character entry box numbers are defined on the application programs, they are not necessarily printed on the character entry sheet 30a shown in FIG. 4.

The handwritten character font generation program 17 includes a character image extraction section 17a, a character circumscribed quadrilateral calculation section 17b, a character positional information calculation section 17c, a character position alignment section 17d and a character font generation section 17e.

The character entry sheet creation program 25 creates image data of the character entry sheet 30a in response to an instruction for handwritten character font creation by the user.

The character image extraction section 17a extracts character image data of the handwritten characters filled into the character entry boxes from the scanned image data of the filled-in character entry sheet 30b in which the handwritten characters are filled into the character entry boxes corresponding to the respective character codes.

The character circumscribed quadrilateral calculation section 17b calculates a circumscribed quadrilateral of a character portion from the character image data of the handwritten character extracted by the character image extraction section 17a.

The character positional information calculation section 17c calculates the amount of movement for moving the circumscribed quadrilateral calculated by the character circumscribed quadrilateral calculation section 17b to a character position of a font character space defined in the specific character positional information database 19b.

The character position alignment section 17d moves the character image data of the handwritten character to a character position defined in the ordinary character positional information database 19a, based on the amount of movement calculated by the character positional information calculation section 17c.

The character font generation section 17e converts the character image data of the handwritten character moved by the character position alignment section 17d to vector data and generates font characters as an outline font.

In addition, although not illustrated, a start up program of the personal computer 10 and driver programs of the image scanner 5 and the printer 20 are also stored in the ROM 13.

The input/output interface section 14 controls input/output processing of information among the personal computer 10 and the image scanner 5 and the printer 20, and converts the inputted/outputted information to a data form suitable for subsequent processings.

The font character image memory 16 stores the handwritten character font generated by the CPU 11. In addition, in the font character image memory 16, the handwritten character font is stored at an address corresponding to the peculiar character code of each font character, and the CPU 11 is configured to read out the font character of the handwritten character font to the RAM 12 according to a specified character code.

[Processing of Handwritten Character Font Generation]

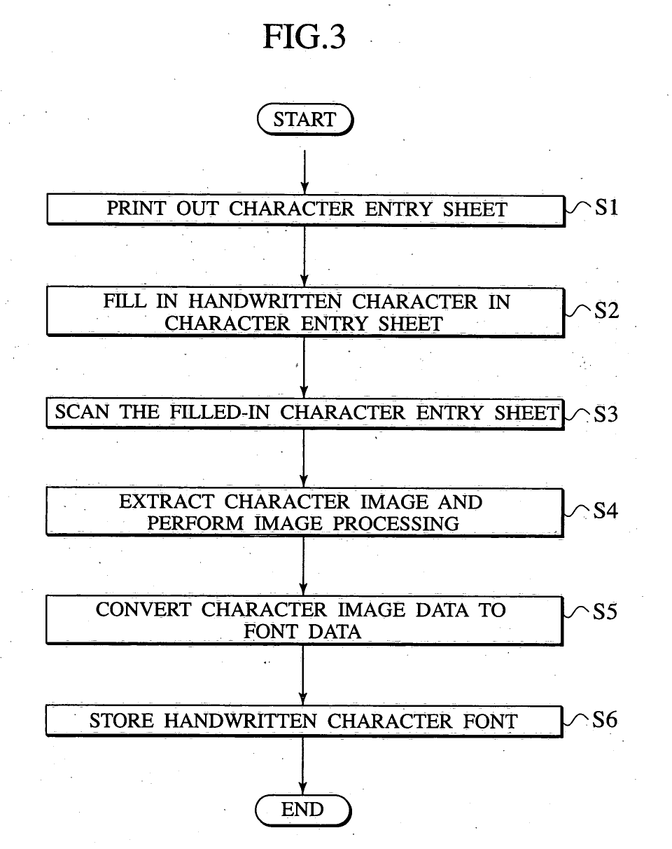

Hereinafter, with reference to the flow chart shown in FIG. 3, the outline of processing will be explained from after the handwritten character font generation apparatus creates the image data of the character entry sheet 30a until the created handwritten character font is stored in the font character image memory 16.

In the flow chart shown in FIG. 3, when the CPU 11 loads the character entry sheet creation program 25 and the handwritten character font generation program 17 stored in the application program storage section 18 to the RAM 12 and executes the loaded programs, according to the instructions by the user, the processing is started.

In Step S1, the CPU 11 executes the character entry sheet creation program 25, and creates image data of the character entry sheet 30a in response to instructions by the user and sends the created image data to the printer 20. And then, the printer 20 prints out the character entry sheet 30a based on the sent image data.

Here, the character entry sheet 30a printed by the printer 20 has a layout as shown in FIG. 4. That is, m lines (lines 33a to 33m) are allocated on the character entry sheet 30a, and plural character entry boxes 36 (36a to 36n in FIG. 4) in which the font character of the handwritten character font can be entered are arranged at each of the lines. Further, the number of the character entry sheet 30a printed varies according to the number of font characters of the handwritten character font which the user needs, and the page number is printed by a page number display field 32.

Further, a bar code 31 for discriminating the page of the character entry sheet 30a is printed. Furthermore, font characters 34 (34a to 34n in FIG. 4) of the representative character font corresponding to the handwritten character to be filled in is printed by the upper side of each of the character entry boxes 36 respectively. Therefore, the user fills in a character into each of the character entry boxes 36 in handwriting with reference to each of the font characters 34.

Moreover, cancellation check mark entry boxes 35 (35a to 35n in FIG. 4) are arranged by the upper side of each of the character entry boxes 36 respectively. The user fills a mark (for example, check mark, paint out the cancellation check mark entry box, etc.) into the cancellation check mark entry box 35, when the character filled into the character entry box 36 has been miswritten.

Here, “miswriting” means an entry mistake due to various factors, such as a mistake in filling in a “Hen” (i.e., left-hand radicals of the “Kanji” characters (Japanese characters)), filling in four horizontal lines as lines constituting “Tsukuri” (i.e., right-hand radicals of the “Kanji”) instead of three lines, the “Hen” or the “Tsukuri” of the “Kanji” character differ from the intended arrangement, or the like.

Further, writing implements used for filling in are not limited especially. For example, writing implements, such as a fountain pen, a ballpoint pen, a calligraphy brush or the like, which satisfy a color and a density adequate for being scanned by the image scanner 5, can be used.

In Step S2, handwritten characters are filled into the character entry boxes 36 of the character entry sheet 30a by the user, and the filled-in character entry sheet 30b is set to the image scanner 5.

In Step S3, the image scanner 5 scans the image of the filled-in character entry sheet 30b and sends the scaned image data to the personal computer 10, according to the control by the CPU 11.

In Step S4, the input/output interface section 14 stores the image data sent from the image scanner 5 in the RAM 12. The CPU 11 performs a series of processings, such as character image extraction, image processing, etc. to the image data stored in the RAM 12, and creates character image data.

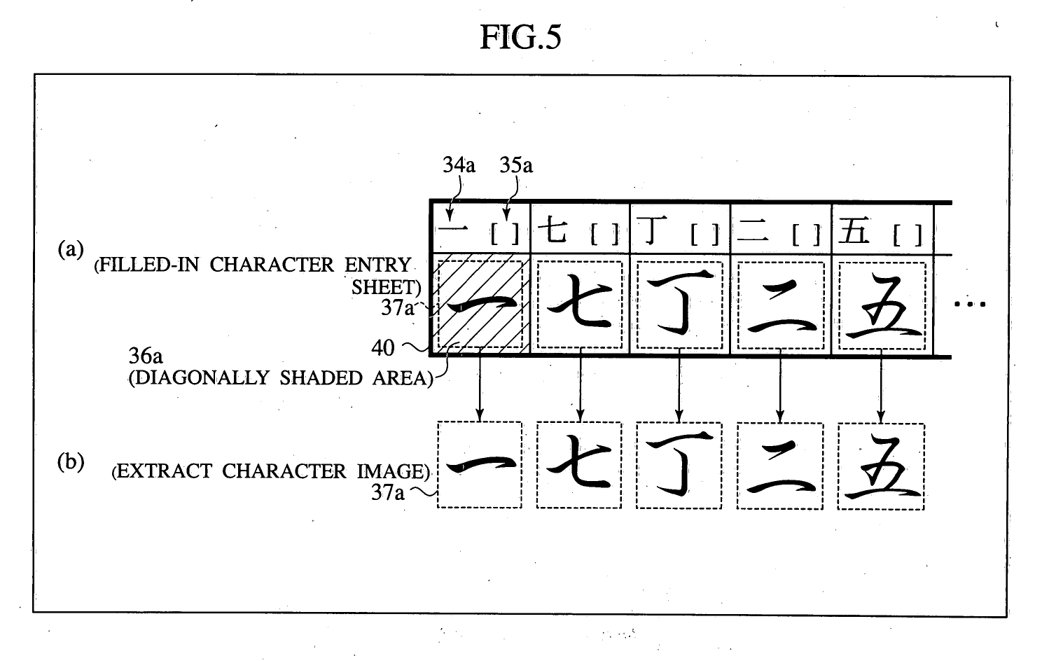

Here, in the processing of the step S4, the CPU 11 extracts the character image of each character entry box 36 of the handwritten characters based on a cutting frame 37 using the character image extraction section 17a. More specifically, as shown in FIG. 5, the character image extraction section 17a detects a heavy line box 40 of the character entry box 36 from the image data of the filled-in character entry sheet 30b stored in the RAM 12, and extracts the character image data from each character entry box 36 (every character code) based on the cutting frame 37 (37a to 37n in FIG. 4).

In Step S5, the CPU 11 converts the extracted character image data to vector data using the character font generation section 17e and generates font characters of the handwritten character font corresponding to each of the character codes.

In step S6, the CPU 11 stores the generated font characters of the handwritten character font in the font character image memory 16 corresponding to the character code using the character font generation section 17e. As mentioned above, the series of processings is completed and the font based on the user's own handwritten characters can be generated.

However, when the document etc. was drawn up using a handwritten character font created based on handwritten characters, since intervals between the character pictures and the row of the characters of the printed document are confused, there was problem which becomes unsightly. As a result of analyzing the sample (the filled-in character entry sheet 30b) filled with the handwritten characters, there is variation in the size of the filled in handwritten characters and the positioning of the handwritten characters filled into the character entry boxes 36 even if the user is same, and it become clear that this variation is the primary cause to which the printed document becomes unsightly.

In order to reduce such a fault, for example, in the case where a handwritten character font is created, it can be considered that a character standard position is computed from a right-angled quadrilateral (herein below, abbreviated to “circumscribed quadrilateral”) circumscribing a character portion of character image data of a handwritten character, and the character portion of the character image data of the handwritten character is moved to the specific position of a font space established in advance about each of characters parallel to itself. However, only by moving parallel to the character image data of the handwritten character, if the character size of the handwritten character is large, there may be cases where the character portion of the character image data overflows font character space. Moreover, in generally, if the specific position of font space is defined to specific characters, such as voiced sound characters and p-sound characters among “Hiragana” characters and “Katakana” characters, there is a problem that the arrangement becomes imbalanced depending on a form of the handwritten characters filled in by the user.

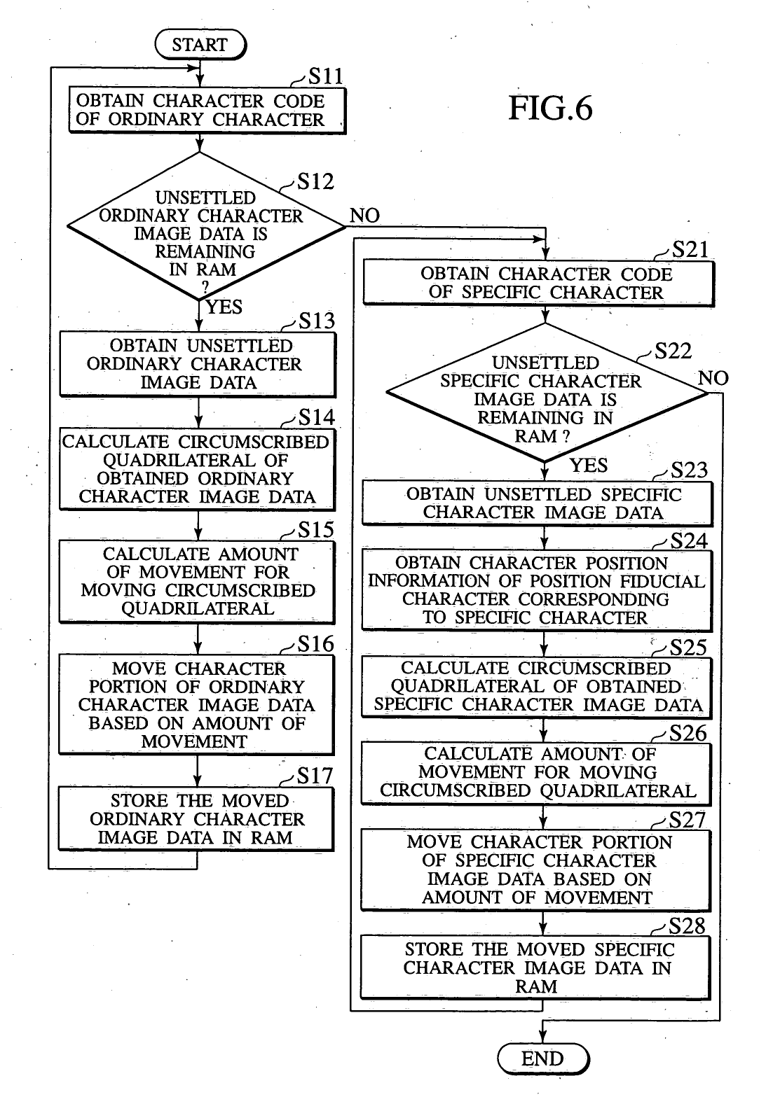

Therefore, the handwritten character font generation apparatus of the present embodiment, in the above Step S4, creates the font character of the handwritten character font by performing image processing shown below to the character image data of the handwritten characters in order to reduce the above faults. Hereafter, with reference to the flowchart shown in FIG. 6, the processing operation of the handwritten character font generation apparatus will be explained.

[Image Processing]

The flow chart of FIG. 6 shows the details of the processing of the Step S4 shown in FIG. 3. From after the character image extraction section 17a extracts the character image data of each handwritten characters from the image data of the filled-in character entry sheet 30b stored in the RAM 12 and stores the extracted character image data in the RAM 12, the processing of the flow chart of shown in FIG. 6 is started.

In Step S11, the character image extraction section 17a obtains character codes of ordinary characters from the ordinary character positional information database 19a.

In Step S12, the character image extraction section 17a discriminates whether the unsettled character image data of the ordinary characters (herein below, abbreviated to “ordinary character image data”) remains in the RAM 12. As a result of the discrimination, if no unsettled ordinary character image data is remaining in the RAM 12, this processing goes to Step S21. On the other hand, if the unsettled ordinary character image data is remaining in the RAM 12, this processing goes to Step S13.

In Step S13, the character image extraction section 17a obtains the unsettled ordinary character image data from the RAM 12, corresponding to the obtained character code of the ordinary character.

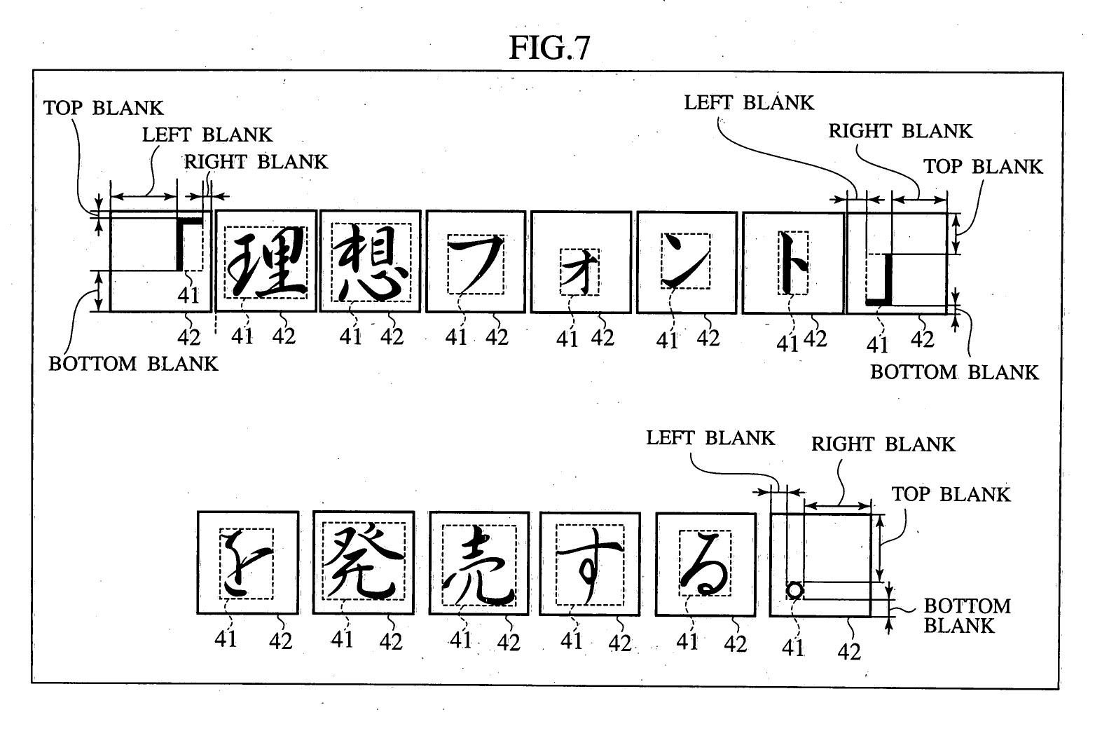

In Step S14, the character circumscribed quadrilateral calculation section 17b calculates a circumscribed quadrilateral 41 of the obtained ordinary character image data, and calculates a left blank, a right blank, a top blank, and a bottom blank of the circumscribed quadrilateral 41 of the ordinary character image data in the font character space 42. Here, as shown in FIG. 7, “left blank”, “right blank”, “top blank”, and “bottom blank” mean distance between the each side of the circumscribed quadrilateral 41 of the ordinary character image data and the relative each side of the font character space 42. For example, the left blank is the distance between the left side of the circumscribed quadrilateral 41 of the ordinary character image data and the left side of the font character space 42.

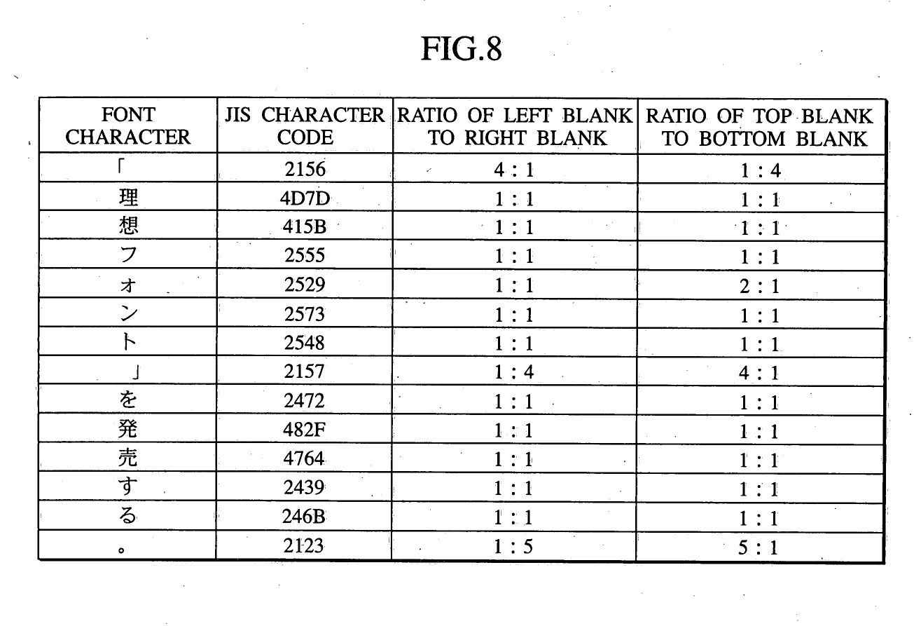

In Step S15, the character positional information calculation section 17c searches in the ordinary character positional information database 19a based on the obtained character code of the ordinary character and obtains character positional information of the font character space 42. As an example shown in FIG. 8, the ordinary character positional information database 19a stores the predetermined character positional information of each the ordinary characters. The character positional information indicates the “position where it should originally be” of the font character in the font character space 42, and is constituted by the information about the ratio of the left blank to the right blank and the ratio of the top blank to the bottom blank of the circumscribed quadrilateral 41 of the font character image data in the font character space 42.

As shown in FIG. 8, for example, the character positional information of Japanese symbol character of the “period” (JIS character code is “2123”) is defined as follows:

Left blank:Right blank=1:5 (1)

and

Top blank:Bottom blank=5:1. (2)

Further, the character positional information calculation section 17c calculates the amount of movement for moving the circumscribed quadrilateral 41 of the ordinary character image data, based on the obtained character positional information and the ratio of the left blank to the right blank and the ratio of the top blank to the bottom blank of the circumscribed quadrilateral 41 of the ordinary character image data in the font character space 42 calculated in the Step Sl4. That is, the character positional information calculation section 17c calculates the amount of movement of the circumscribed quadrilateral 41 of the ordinary character image data so that the ratio of the left blank to the right blank and the ratio of the top blank to the bottom blank of the circumscribed quadrilateral 41 of the ordinary character image data in the font character space 42 are in agreement with the ratio of the left blank to the right blank and the ratio of the top blank to the bottom blank of the circumscribed quadrilateral 41 of the font character image data in the font character space 42 defined in the character positional information. Furthermore, the character positional information calculation section 17c stores each of the blank information (distance values) in the font character space 42 in the RAM 12.

In Step S16, the character positional alignment section 17d moves the character portion of the ordinary character image data based on the calculated amount of movement.

In Step S17, the character positional alignment section 17d stores the moved ordinary character image data corresponding to the character code. And then, this processing returns to Step S11, and each above-mentioned processings in the Step S11 to S17 are repeated until unsettled ordinary character image data is not remaining in the RAM 12.

As a result of the discrimination in the Step S12, if no unsettled ordinary character image data is remaining in the RAM 12, in Step S21, the character image extraction section 17a obtain character codes of specific characters from the specific character positional information database 19b.

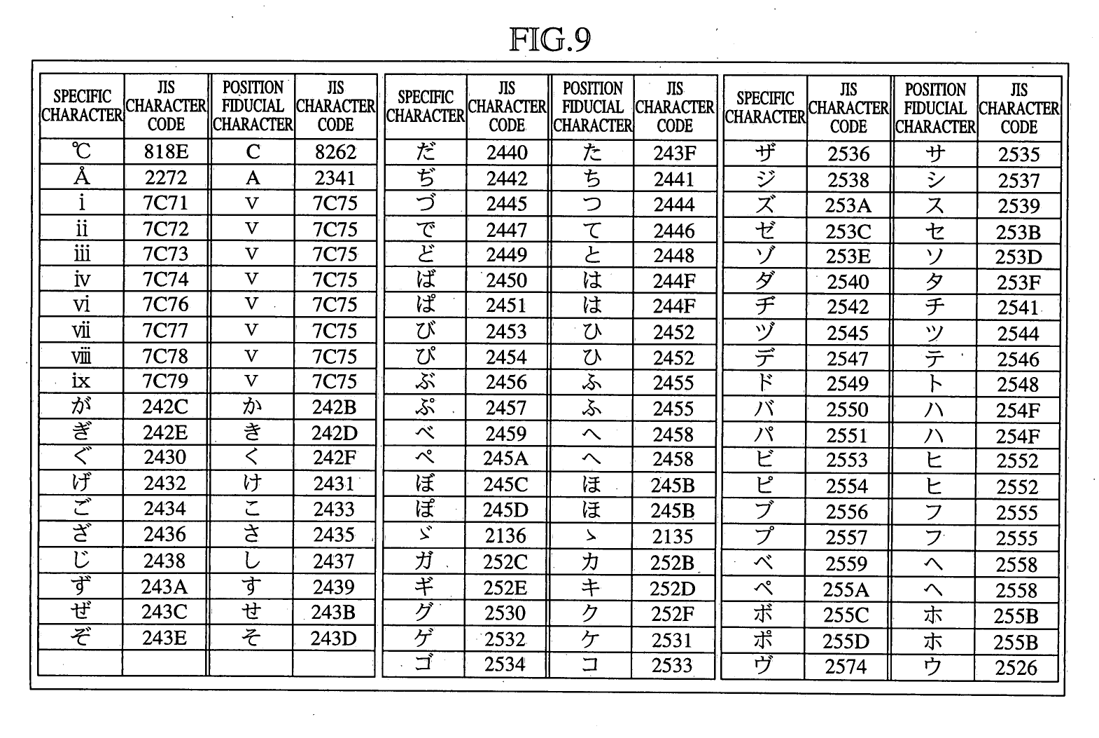

In addition, “specific character” means characters, such as at least voiced sound characters and p-sound characters among “Hiragana” characters and “Katakana” characters, Roman numerals of a lower-case character. As an example shown in FIG. 9, the specific character positional information database 19b stores position fiducial characters corresponding to each of the specific characters. In addition, the number of the specific characters may be fluctuated suitably by adding/deleting of the position fiducial characters and the character codes.

As shown in FIG. 9, for example, the position fiducial character corresponding to the specific character “C” (Japanese symbol character meaning “degree Celsius”; JIS character code is “818E”) is defined as an upper case alphabetic character “C” (JIS character code is “8262”), and the position fiducial character corresponding to the specific character “i” (a lower-case Roman numeral character; JIS character code is “7C71”) is defined as a lower-case Roman numeral character “v” (JIS character code is “7C75”).

In Step S22, the character image extraction section 17a discriminates whether the unsettled character image data of the specific characters (herein below, abbreviated to “specific character image data”) remains in the RAM 12 referring the obtained the character codes of the specific characters. As a result of the discrimination, if noun settled specific character image data is remaining in the RAM 12, this processing is completed. On the other hand, if the unsettled specific character image data is remaining in the RAM 12, this processing goes to Step S23.

In Step S23, the character image extraction section 17a obtains the unsettled specific character image data from the RAM 12, corresponding to the obtained character code of the specific character.

In Step S24, the character circumscribed quadrilateral calculation section 17b obtains character positional information of the position fiducial character corresponding to the character code of the specific character, referring to the specific character positional information database 19b. Further, the character circumscribed quadrilateral calculation section 17b obtains blank information, calculated and stored in the RAM 12 in the Step S15, based on the character code of the position fiducial character.

In Step S25, the character circumscribed quadrilateral calculation section 17b calculates the circumscribed quadrilateral 41 of the obtained specific character image data, and calculates a left blank, a right blank, a top blank, and a bottom blank of the circumscribed quadrilateral 41 of the specific character image data in the font character space 42.

In Step S26, the character positional information calculation section 17c calculates the amount of movement for moving the circumscribed quadrilateral 41 of the specific character image data in the font character space 42 based on the obtained character positional information of the position fiducial character.

In Step S27, the character positional alignment section 17d moves the character portion of the specific character image data in the font character space 42 based on the calculated amount of movement.

In Step S28, the character positional alignment section 17d matches the moved specific character image data with the character code, and stores in the RAM 12. And then, this processing returns to Step S21, and each above-mentioned processings in the Step S21 to S28 are repeated until unsettled specific character image data is not remaining in the RAM 12.

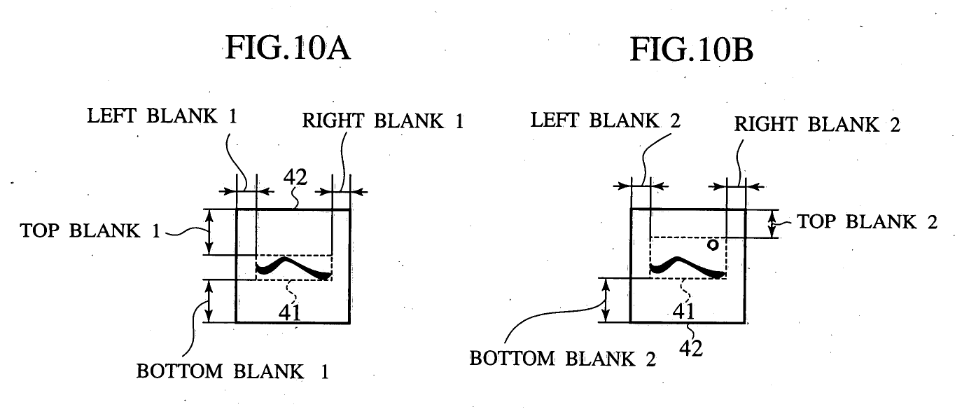

More specifically explains with reference to FIGS. 10A and 10B, since the position fiducial character corresponding to the specific character “Pe” (“Hiragana” character shown in FIG. 10B; JIS character code is “245A”) is defined as a character “He” (“Hiragana” character shown in FIG. 10A; JIS character code is “2458”) as shown in FIG. 9, the amount of movement of the circumscribed quadrilateral 41 of the specific character image data in the font character space 42 is calculated in accordance with the following criteria:

Left blank 2:Right blank 2=Left blank 1:Right blank 1 (3)

and

Bottom blank 2=Bottom blank 1 (4)

(where Top blank 2≧0)

where Left blank 1, Right blank 1, Top blank 1 and Bottom blank 1 are blanks of the position fiducial character, and Left blank 2, Right blank 2, Top blank 2 and Bottom blank 2 are blanks of the specific character.

That is, the character positional information calculation section 17c calculates the amount of movement of the circumscribed quadrilateral 41 of the specific character “Pe” in the font character space 42 so that the ratio of the Left blank 2 to the Right blank 2 of the circumscribed quadrilateral 41 of the specific character “Pe” in the font character space 42 is in agreement with the ratio of the Left blank 1 to the Right blank 1 of the circumscribed quadrilateral 41 of the position fiducial character “He” in the font character space 42, and the Bottom blank 2 of the circumscribed quadrilateral 41 of the specific character “Pe” is in agreement with the Bottom blank 1 of the circumscribed quadrilateral 41 of the position fiducial character “He”. At this time, there is a necessary condition that the circumscribed quadrilateral 41 of the specific character “Pe” fits in the font character space 42.

Returning to the flow chart of FIG. 3, in Step S5, the character font generation section 17e converts the character image data of the ordinary characters and the specific characters, which the above-mentioned processing is performed and is stored in the RAM 12, to vector data, and generates an outline font.

In step S6, the character font generation section 17e stores the generated outline font in the font character image memory 16 corresponding to the character code.

As is clear from above explanation, according to the apparatus, the method, and the computer-readable storage medium recording the program for generating handwritten character fonts based on user's handwritten characters of the present embodiment, since the character portion of the character image data is moved to the position of the character positional information of the font character space 42 defined for every font and then font characters are created, the handwritten character font which can be printed with an attractive appearance in the case of printing documents drawn up using the handwritten character font can be created easily. In particular, when printing using the font characters such as voiced sound characters among “Hiragana” characters and “Katakana” characters, p-sound characters among “Hiragana” characters and “Katakana” characters, and Roman numerals of a lower-case character, documents are printed with an attractive appearance.

Although the embodiments of the present invention have been described in detail, the present invention may be embodied in other specific forms without departing from the spirit or essential characteristics thereof. Thus, the present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

This application claims benefit of priority under 35 USC §119 to Japanese Patent Application No. 2002-310904 filed on Oct. 25, 2002, the entire contents of which are incorporated by reference herein.

What is claimed is:

1. An apparatus for handwritten character font generation comprising:
a character image extraction section configured to extract character image data of handwritten characters filled into character entry boxes from image data scanned from a character entry sheet in which the handwritten characters are filled into the character entry boxes corresponding to respective character codes;
a character positional information storage section configured to store character positional information of font character space defined for each of characters;
a character positional information calculation section configured to calculate the amount of movement for moving the extracted character image data to a character position of the font character space defined in the character positional information;
a character position alignment section configured to move the character image data to the character position of the font character space defined in the character positional information, based on the calculated amount of movement; and
a character font generation section configured to generate font characters of the handwritten character font based on the moved character image data.

2. The apparatus of claim 1, further comprising
a character circumscribed quadrilateral calculation section configured to calculate a circumscribed quadrilateral of a character portion of the character image data from the extracted character image data, wherein:
the character positional information calculation section calculates the amount of movement for moving the calculated circumscribed quadrilateral to the character position of the font character space defined in the character positional information; and
the character position alignment section moves the character image data to the character position of the font character space defined in the character positional information by moving the character portion of the character image data based on the calculated amount of movement.

3. The apparatus of claim 2, wherein
the character positional information includes information about a ratio of a top blank to a bottom blank and a ratio of a left blank to a right blank of the circumscribed quadrilateral in the font character space.

4. The apparatus of claim 1, wherein
the character positional information includes information which defines position fiducial characters corresponding to each of specific characters and information which defines a positional relation between each of the specific characters and each of the position fiducial characters respectively.

5. The apparatus of claim 2, wherein
the character positional information includes information which defines position fiducial characters corresponding to each of specific characters and information which defines a positional relation between each of the specific characters and each of the position fiducial characters respectively.

6. The apparatus of claim 3, wherein
the character positional information includes information which defines position fiducial characters corresponding to each of specific characters and information which defines a positional relation between each of the specific characters and each of the position fiducial characters respectively.

7. The apparatus of claim 4, wherein
the specific characters includes voiced sound characters among Hiragana characters and Katakana characters, p-sound characters among Hiragana characters and Katakana characters, and Roman numerals of a lower-case character.

8. The apparatus of claim 5, wherein
the specific characters includes voiced sound characters among Hiragana characters and Katakana characters, p-sound characters among Hiragana characters and Katakana characters, and Roman numerals of a lower-case character.

9. The apparatus of claim 6, wherein
the specific characters includes voiced sound characters among Hiragana characters and Katakana characters, p-sound characters among Hiragana characters and Katakana characters, and Roman numerals of a lower-case character.

10. A computer readable storage medium recording a program for handwritten character font generation, the program executing in a handwritten character font generation apparatus, the program comprising:
extracting character image data of handwritten characters filled into character entry boxes from image data scanned from a character entry sheet in which the handwritten characters are filled into the character entry boxes corresponding to respective character codes;
calculating the amount of movement for moving the extracted character image data to a character position of font character space defined in character positional information;
moving the character image data to the character position of the font character space defined in the character positional information based on the calculated amount of movement; and
generating font characters of the handwritten character font based on the moved character image data.

11. The computer readable storage medium of claim 10 wherein the program further comprising
calculating a circumscribed quadrilateral of a character portion of the character image data from the extracted character image data, wherein:
the amount of movement for moving the calculated circumscribed quadrilateral to the character position of the font character space defined in the character positional information is calculated; and
the character image data to the character position of the font character space defined in the character positional information by moving the character portion of the character image data is moved based on the calculated amount of movement.

12. The computer readable storage medium of claim 11 wherein
the character positional information includes information about a ratio of a top blank to a bottom blank and a ratio of a left blank to a right blank of the circumscribed quadrilateral in the font character space.

13. The computer readable storage medium of claim 10 wherein
the character positional information includes information which defines position fiducial characters corresponding to each of specific characters and information which defines a positional relation between each of the specific characters and each of the position fiducial characters respectively.

14. The computer readable storage medium of claim 11 wherein
the character positional information includes information which defines position fiducial characters corresponding to each of specific characters and information which defines a positional relation between each of the specific characters and each of the position fiducial characters respectively.

15. The computer readable storage medium of claim 12 wherein
the character positional information includes information which defines position fiducial characters corresponding to each of specific characters and information which defines a positional relation between each of the specific characters and each of the position fiducial characters respectively.

16. The computer readable storage medium of claim 13 wherein
the specific characters includes voiced sound characters among Hiragana characters and Katakana characters, p-sound characters among Hiragana characters and Katakana characters, and Roman numerals of a lower-case character.

17. The computer readable storage medium of claim 14 wherein
the specific characters includes voiced sound characters among Hiragana characters and Katakana characters, p-sound characters among Hiragana characters and Katakana characters, and Roman numerals of a lower-case character.

18. The computer readable storage medium of claim 15 wherein
the specific characters includes voiced sound characters among Hiragana characters and Katakana characters, p-sound characters among Hiragana characters and Katakana characters, and Roman numerals of a lower-case character.

19. A method for handwritten character font generation in an apparatus for handwritten character font generation, the method comprising:
extracting character image data of handwritten characters filled into character entry boxes from image data scanned from a character entry sheet in which the handwritten characters are filled into the character entry boxes corresponding to respective character codes;
calculating the amount of movement for moving the extracted character image data to a character position of font character space defined in character positional information;
moving the character image data to the character position of the font character space defined in the character positional information based on the calculated amount of movement; and
generating font characters of the handwritten character font based on the moved character image data.

20. The method of claim 19, further comprising
calculating a circumscribed quadrilateral of a character portion of the character image data from the extracted character image data, wherein:
the amount of movement for moving the calculated circumscribed quadrilateral to the character position of the font character space defined in the character positional information is calculated; and
the character image data to the character position of the font character space defined in the character positional information by moving the character portion of the character image data is moved based on the calculated amount of movement.
